(19) United States
(12) Patent Application Publication
(10) Pub. No.: US 2015/0184540 A1
(43) Pub. Date: Jul. 2, 2015

(54) SYSTEM AND METHOD FOR BEARINGS

(71) Applicant: Energy Recovery, Inc., San Leandro, CA (US)

(72) Inventors: Felix Winkler, Oakland, CA (US); Farshad Ghasripoor, Berkeley, CA (US)

(21) Appl. No.: 14/583,918

(22) Filed: Dec. 29, 2014

Related U.S. Application Data
(60) Provisional application No. 61/922,465, filed on Dec. 31, 2013.

(51) Int. Cl. F01D 25/16; B22F 3/105; F16C 32/06; B23K 1/20; F16C 43/00; B23K 1/00; C04B 35/622

(52) U.S. Cl. CPC F01D 25/16; B23K 1/0018; B22F 3/1055; C04B 35/622; B23K 1/20; F16C 43/00; F16C 32/06; B23K 2001/12; B22F 2003/242

(57) ABSTRACT

A method for manufacturing a rotating assembly includes providing an impeller including a shaft and at least one blade. The method also includes providing a thrust plate configured to contact a bearing fluid. The method further includes brazing the thrust plate to the impeller.

### CROSS-REFERENCE TO RELATED APPLICATION

This application claims priority to and benefit of U.S. Provisional Application No. 61/922,465, entitled “SYSTEM AND METHOD FOR BEARINGS,” filed on Dec. 31, 2013, which is hereby incorporated by reference in its entirety for all purposes.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

The subject matter disclosed herein relates to rotating equipment, and, more particularly, to systems and methods for using bearings with rotating equipment.

Rotating equipment may handle a variety of fluids. Some of these fluids may include various contaminants, such as solids, particles, powders, debris, and so forth, which may interfere with the operation of the rotating equipment. In certain rotating equipment, various components, such as bearings, may be lubricated by the process fluid handled by the rotating equipment. The contaminants that may be present in the process fluid may negatively affect the operation of the components, potentially decreasing the life of the components. Existing techniques for addressing the effects of contaminants present in the process fluid may include filtering the process fluid or using a separate source of uncontaminated lubricating fluid. Unfortunately, such techniques may be costly, time-consuming, maintenance-intensive, complicated, and/or may allow smaller contaminants to negatively affect the components of the rotating equipment.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a cross-section of an embodiment of a thrust pad bearing according to the present technology;

FIG. 2 is a flow chart illustrating an embodiment of a method according to the present technology;

FIG. 3 is a perspective view of an embodiment of a shroud undergoing a stress analysis according to the present technology;

FIGS. 4A and 4B are cross-sections of an embodiment of a turbine and thrust bearing assembly according to the present technology;

FIGS. 5A, 5B, and 5C are various views of an embodiment of a shroud and thrust runner combination according to the present technology;

FIG. 6 is a cross-sectional view of an embodiment of a rotating assembly thrust plate;

FIG. 7 is a flowchart of a method that may be used to fabricate an embodiment of a rotating assembly thrust plate using brazing; and

FIG. 8 is a flowchart of a method that may be used to fabricate an embodiment of a rotating assembly thrust plate using an additive manufacturing process.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

As discussed in detail below, the disclosed embodiments relate generally to rotating equipment, and particularly to using bearings with rotating equipment. For example, the rotating equipment may handle a variety of fluids, some of which may include contaminants, solid particles, powders, debris, and so forth. The rotating equipment may use the process fluid to lubricate certain components, such as bearings. In some embodiments, the bearings may be fabricated using the disclosed techniques, which may increase the life of the bearings when handling the contaminant-laden fluids. For example, in certain embodiments, one or more components of a bearing assembly may be made from a hard material with a hardness greater than that of the contaminants. The disclosed techniques may include using brazing, an additive manufacturing process, or other methods to attach the hard material to the bearing assembly and/or to fabricate the bearing assembly out of the hard material. By using the disclosed techniques, the distortion, high internal stresses, degradation of adhesives, and other disadvantages associated with other methods of attaching hard materials to bearing assemblies may be avoided. In addition, use of the disclosed techniques may enable filters or dedicated bearing lubrication fluid systems to be omitted, thereby eliminating the costs, maintenance, and complexity associated with these prior methods.

A thrust bearing described herein may be used in a pump, turbine, or turbocharger. In a turbine application to recover energy from high pressure natural gas or a water amine mixture after a natural gas sweetening operation, the thrust bearing provided herein may be durable and debris resistant. The thrust bearing may operate at high speeds and may be lubricated by a portion of the fluid flowing through the turbine or pump, which is also referred to herein as a process lubricated turbine or pump. All of the surfaces in the process lubricated turbine or pump may therefore be wetted surfaces, and therefore tolerant of debris that is common in the fluids associated with a gas sweetening operation. A thrust bearing according to the disclosed technology may be used in any application requiring a debris resistant high speed bearing.

The resistance to wear is provided in the described thrust bearing by a thrust runner, also referred to herein as a disk, which may be ceramic, graphite, or metallic carbide. The thrust runner may be installed in a shroud with a thermal fit that involves installing the thrust runner in the shroud during a high temperature operation. Alternatively, the installation operation may involve cooling the disk. The compression of the thermal fit may strengthen the thrust runner and improve its performance during operation.

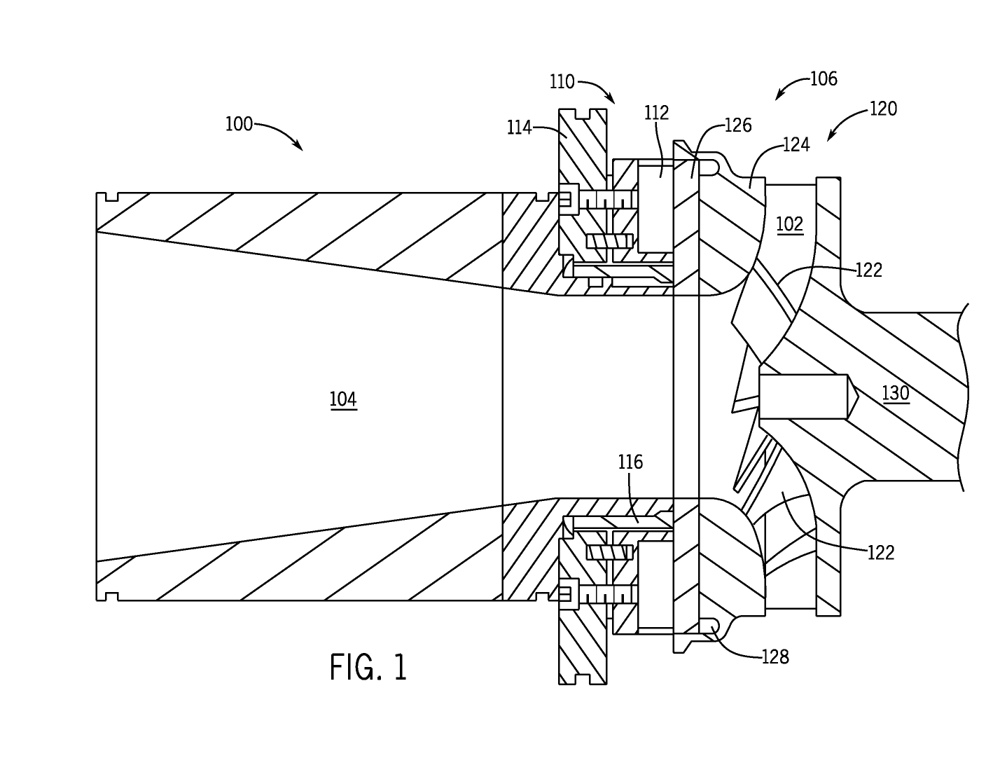

FIG. 1 is a cross-section of an embodiment of a turbine 100. Alternatively, element 100 may be a pump or a turbocharger. The turbine 100 includes an inlet channel 102 and a diffuser 104. Alternatively, the inlet channel 102 may be an outlet and the diffuser 104 may be an inlet, particularly when element 100 is a pump. The turbine 100 includes a thrust pad bearing 106, which is a combination of a fixed assembly 110 and a rotating assembly 120.

The fixed assembly 110 includes a tilting pad 112, which may be made of silicon carbide or ceramic supported by a stainless steel arrangement, or any other appropriate material. The fixed assembly 110 also includes a tilting pad bearing base 114, which may be made of stainless steel, or any other appropriate material, and which may be coupled to tilting pad 112 by connectors that may include spring or rocking elements. The fixed assembly 110 further includes a mechanical seal 116, which may be made of silicon carbide, tungsten carbide, polyether ether ketone (also referred to as PEEK) or ceramic, or any other appropriate material.

The rotating assembly 120 includes a shroud 124 (e.g., an annular shroud), which may be made of stainless steel, or any other appropriate material. The shroud 124 may house blades 122. The portions of the shroud 124 that houses the blades 122 may also be referred to herein and generally as a turbine runner. The blades 122 may be, in some embodiments, a single blade, but in alternative embodiments, the blades 122 may be a plurality of blades arranged in a fan configuration. The rotating assembly 120 also includes a thrust runner 126 (e.g., an annular thrust runner), which may be made of silicon carbide or other ceramic, or any other appropriate material, and which may be seated in a recess (e.g., an annular recess) of the shroud 124. In certain embodiments, the thrust runner 126 may be installed in a recess of the shroud 124 using a high temperature assembly operation such that, after cooling, the shroud 124 may compress and hold the thrust runner 126 in a thermal fit relationship (e.g., a shrink fit relationship or interference fit). The shroud 124 may also include a cavity 128 (e.g., an annular cavity) adjacent and contiguous with the recess that receives the thrust runner 126, and which may remain vacant after the thrust runner 126 is seated in the recess.

During operation, fluid under high pressure flows into the inlet channel 102 and out the diffuser 104, which causes the blades 122 to rotate. The rotation of the blades 122 causes the rotating assembly 120 to rotate, which in turn causes a shaft 130 to rotate. The rotating assembly 120 may rotate at a high rate of speed due to the high pressure differential between the zone of fluid prior to entry in the inlet channel 102 and the zone of fluid after exiting the diffuser 104, which may cause the fluid to flow at a high rate of speed. The rotating assembly 120 contacts the fixed assembly 110, and this area of contact may experience a high level of force due to the high pressure condition of the fluid upon entering the inlet channel 102 relative to the low pressure condition of the fluid upon exiting the diffuser 104. The face of the thrust runner 126 that faces the tilting pad 112 may therefore experience a high level of wear due to the combination of the high pressure and the high rate of relative rotational velocity between the thrust runner 126 and the tilting pad 112.

The present technology provides for convenient and easy replacement of the thrust runner 126. In some embodiments, the thrust runner 126 may be removed by reversing the installation operation, for example by heating the combination of the thrust runner 126 and the shroud 124. Alternatively, the thrust runner 126 may be removed by impacting the thrust runner 126 so that it breaks. Subsequently, a new thrust runner 126 may be installed in the shroud 124 and the combination of the thrust runner 126 and the shroud 124 may be installed in the turbine 100 for continued use.

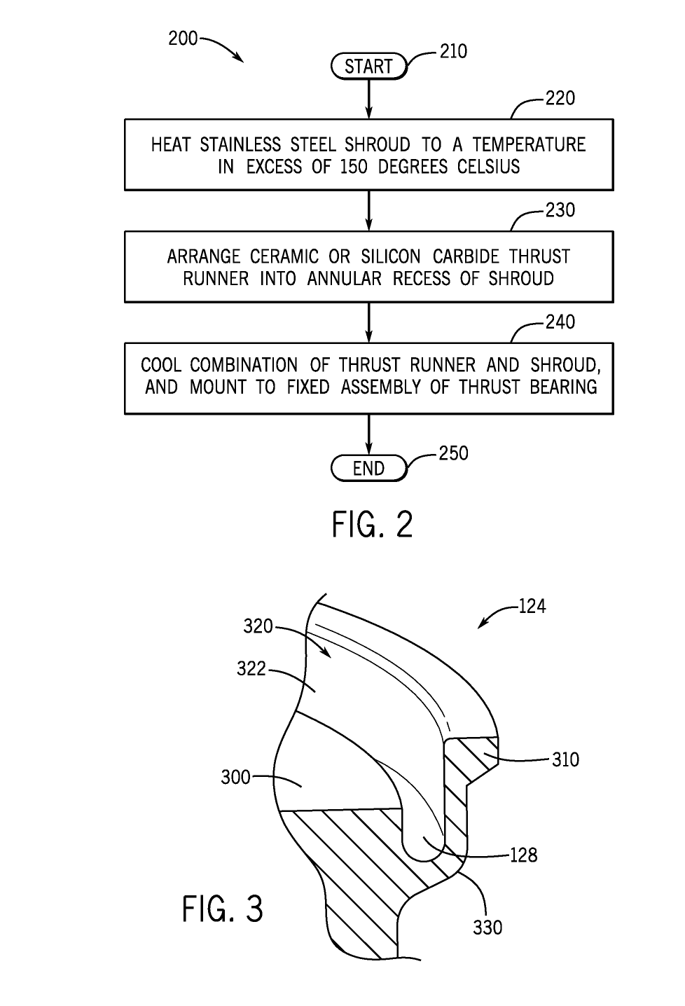

FIG. 2 illustrates method 200 according to the present technology. Method 200 starts at start oval 210 and proceeds to operation 220, which indicates to heat a stainless steel shroud (e.g., the shroud 124) to a temperature in excess of 150 degrees Celsius. Alternatively, the shroud 124 may be made of any one or more of stainless steel, a ceramic material, graphite, polyether ether ketone, and metal carbide. The shroud 124 may be heated to a temperature not in excess of 250 degrees Celsius, and the disk (e.g., the thrust runner 126) may be also be heated along with the shroud 124 during operation 210. From operation 220, the flow proceeds to operation 230, which indicates to arrange a ceramic or silicon carbide thrust runner (e.g., the thrust runner 126) into an annular recess of the shroud 124. The thrust runner 126 is also referred to herein as a disk, and may alternatively include one or more of ceramic, graphite, or metallic carbide. From operation 230, the flow proceeds to operation 240, which indicates to cool the combination of the thrust runner 126 and the shroud 124. Operation 240 further indicates to mount the combination of the thrust runner 126 and the shroud 124 to a fixed assembly (e.g., the fixed assembly 110) of a thrust bearing (e.g., the thrust bearing 106). The fixed assembly 110 is also referred to herein as a stationary element, and may be composed of one or more of a ceramic, graphite, polyether ether ketone, or metallic carbide. From operation 240, the flow proceeds to end oval 250. In still further alternatives, the thrust runner 126 may be cooled, while the shroud 124 remains at room temperature or is heated, prior to operation 230. In the case where both the shroud 124 and the thrust runner 126 are heated during operation 210, the material for the shroud 124 may have a different coefficient of thermal expansion with respect to the material of the thrust runner 126. In this manner, the thermal fit between the thrust runner 126 and the shroud 124 exists for a range of temperatures that includes the operating range, and the thermal fit would not exist at the manufacturing temperature. Therefore, this thermal fit is reversible by raising the temperature of the combination of the shroud 124 and the thrust runner 126 to the manufacturing temperature and removing the thrust runner 126 from the shroud 124. This reversal of the manufacturing process may be very useful in situations in which the thrust runner 126 becomes worn and requires replacement.

FIG. 3 is a perspective view of an exemplary embodiment of shroud 124 undergoing a finite element stress analysis, with different shading representing different amounts of stress. The shroud 124 includes the cavity 128 along an outer perimeter of the annular recess. A face 300 of the shroud 124 defines a position for a thrust runner (e.g., the thrust runner 126). When a thrust runner of an appropriate size (e.g., a size sufficient to create a thermal fit (also referred to as a shrink fit) within the shroud 124) is positioned in the recess of shroud 124, the thrust runner may be compressed by an outer face 320 of the shroud 124. Stress due to this compression is concentrated at a line of contact 322 as well as at an arcuate portion 330 of the cavity 128. A flange 310 of the shroud 124 functions to support the line of contact 322, and is under a considerable amount of hoop stress. These stresses are within tolerance (below the yield stress) for the material used for the shroud 124, and create a sufficiently strong thermal fit to attach a thrust runner (e.g., the thrust runner 126) for use in a high speed turbine or pump (e.g., the element 100).

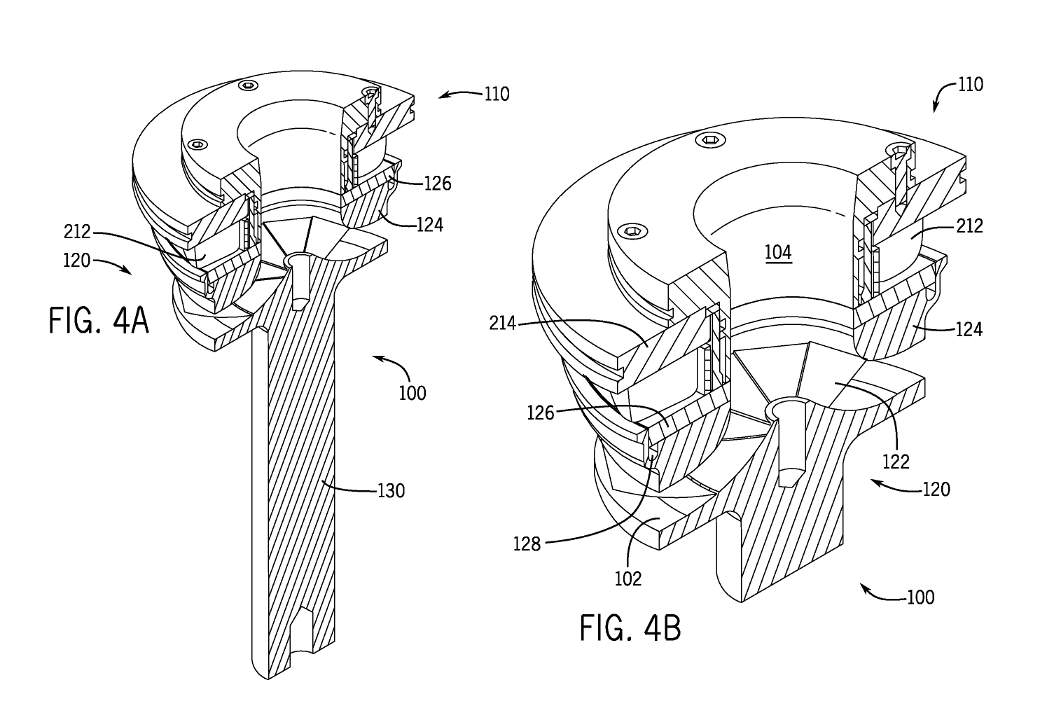

FIG. 4A is a cross-section of an exemplary embodiment of the turbine 100 including the thrust bearing 106 having the fixed assembly 110 and the rotating assembly 120. The rotating assembly 120 is coupled to a shaft 130 and includes the shroud 124 and the thrust runner 126. The thrust runner 126 contacts the fixed assembly 110 at the tilting pad 212.

FIG. 4B is a cross-section of the exemplary embodiment of the turbine 100 shown in FIG. 4A, and additionally illustrates the inlet channel 102, the diffuser 104, and the blades 122. The fixed assembly 110 of the turbine 100 illustrated in FIG. 4B also includes a tilting pad bearing base 132, and the rotating assembly 120 includes the thrust runner 126 seated in the shroud 124 in a thermal fit relationship (e.g., a shrink fit or an interference fit). The shroud 124 includes the cavity 128. FIGS. 4A and 4B are three-dimensional views of FIG. 1.

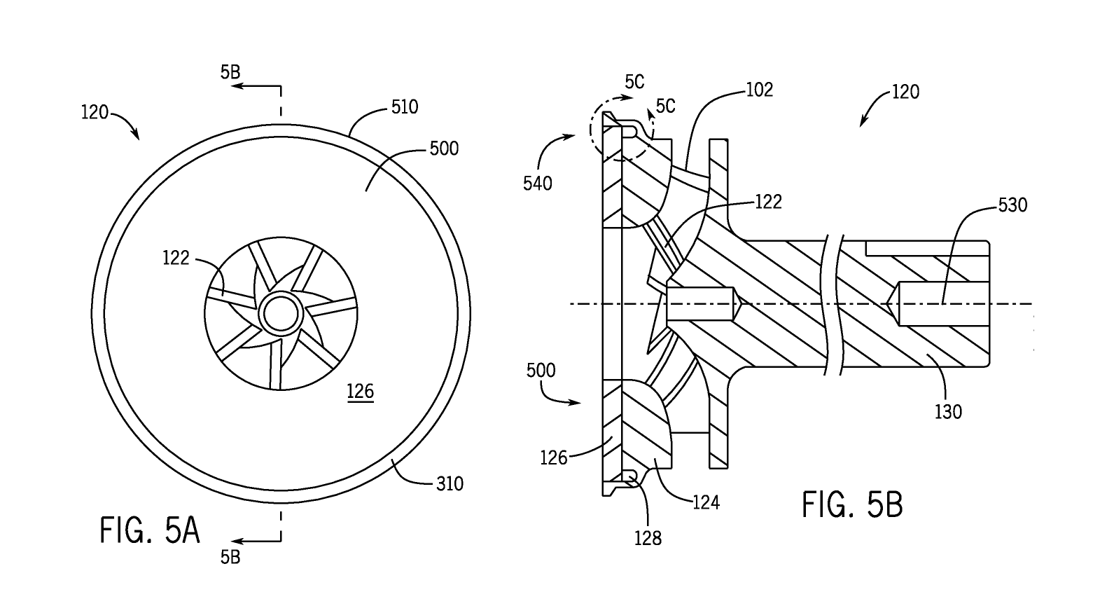

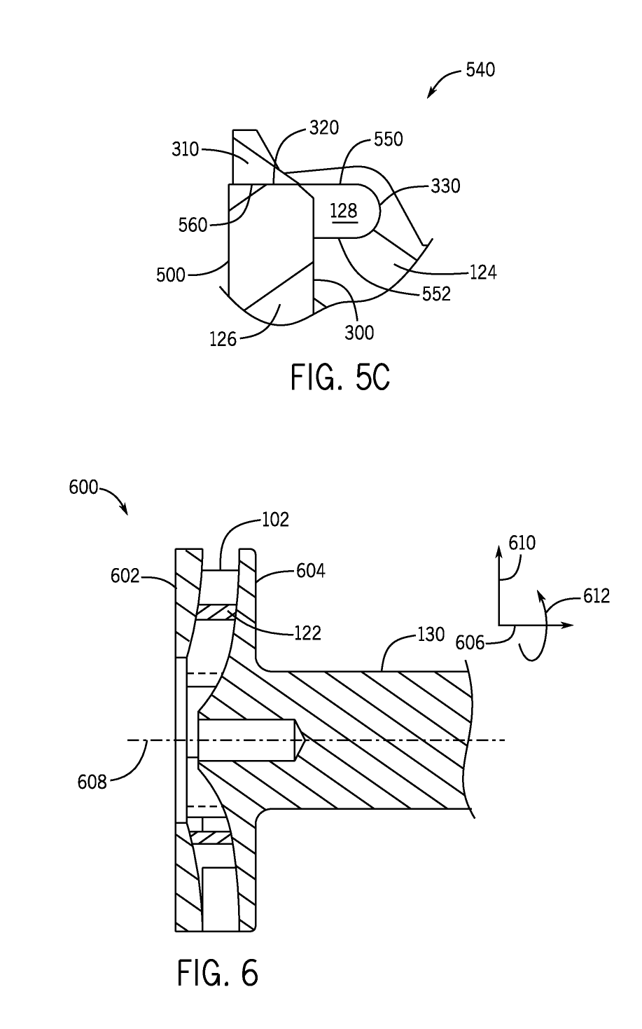

FIG. 5A is a front view of an exemplary embodiment of the rotating assembly 120 including the blades 122 arranged centrally within an annular face 500 of the thrust runner 126. The flange 310 of the shroud 124 is disposed on an outer perimeter 510 of the rotating assembly 120. Cross-sectional line 5B-5B illustrates the section used for FIG. 5B.

FIG. 5B is cross-sectional view of the exemplary embodiment of the shroud 124 and the thrust runner 126 of the rotating assembly 120 taken alone line 5B-5B of FIG. 5A. The thrust runner 126 includes the face 500 and is seated in the shroud 124. The shroud 124 houses the blades 122 occupying the inlet channel 102 and is rigidly coupled to the shaft 130. Also illustrated in FIG. 5B is a central axis 530, about which the rotating assembly 120 rotates. The shroud 124 includes a perimeter zone 540 which is illustrated in more detail in FIG. 5C.

FIG. 5C is a close-up view of the perimeter zone 540 including portions of the shroud 124 and the thrust runner 126. The shroud 124 includes the face 300, on which the thrust runner 126 seats, and the flange 310 on an outer perimeter. The shroud 124 also includes the cavity 128 which is not occupied by the thrust runner 126 but which is contiguous with the recess occupied by the thrust runner 126. The cavity 128 may be U-shaped including an inward side 552 toward the central axis 530 (FIG. 5B), and an outward side 550 away from the central axis 530. The arcuate portion 330 forms a bottom of the cavity 128. The outward side 550 may be parallel to the inward side 552, and may additionally be parallel to the central axis 530, or equivalently perpendicular to the face 500 of the thrust runner 126. Alternatively, the outward side 550 and the inward side 552 may form an angle of varying degrees with the face 500, for example more or less than substantially 90 degrees. In particular, the outward side 550 and the inward side 552 may angle away from the central axis 530 by 5 degrees, or may angle towards the central axis 530 by 5 degrees. An outer diameter 560 of the thrust runner 126 contacts the outer face 320 of the shroud 124, which together represent the area of interference where the thermal fit engages.

The stainless steel used in the devices and methods according to the present technology may include 2205 and 2507 stainless steels, which have a 50% higher yield strength than 316 stainless steel.

FIG. 6 is a cross-sectional view of an embodiment of a rotating assembly 600 including a rotating assembly thrust plate (e.g., thrust runner) 602 fabricated using the disclosed techniques. As shown in FIG. 6, the rotating assembly thrust plate 602 may be attached to an impeller 604 of rotating equipment, such as a pump, compressor, turbine, or rotary machine. The impeller 604 may include a shaft (e.g., the shaft 130), one or more blades (e.g., the blades 122), and an inlet channel (e.g., the inlet channel 102). In the following discussion, reference may be made to various directions or axes, such as an axial direction 606 along a rotational axis 608 of the shaft 130, a radial direction 610 away from the rotational axis 608, and a circumferential direction 612 around the rotational axis 608. As illustrated, the rotating assembly thrust plate 602 may be substantially perpendicular to the rotational axis 608 of the shaft 130. Further, as described in detail above, the rotating assembly thrust plate 602 may be configured to contact the fixed assembly 110. For example, the rotating assembly thrust plate 602 may be configured to contact the tilting pad 112 of the fixed assembly 110.

The rotating assembly thrust plate 602 may be made of only one component (i.e., a one-piece structure or unitary structure). In other words, the rotating assembly thrust plate 602 does not include an assembly of two or more components. That is, the rotating assembly thrust plate 602 may not include a shroud (e.g., the shroud 124) as described above. Such a configuration of the rotating assembly thrust plate 602 may simplify the fabrication of the rotating assembly thrust plate 602, thereby reducing the costs and time associated with fabrication. The rotating assembly thrust plate 602 may be made from a hard material, such as, but not limited to, a cemented carbide, cermet, oxide ceramic, nonoxide ceramic, and so forth. In certain embodiments, as noted above, the rotating assembly thrust plate 602 may be configured to contact a lubricant or a bearing fluid that may include abrasive and/or corrosive particles. In some embodiments, the rotating assembly thrust plate 602 made from a hard material that has a hardness that is greater than a hardness of solid particulates in the bearing fluid (e.g., a bearing fluid including abrasive and/or corrosive particles). For example, the hard material of the plate 602 may have a hardness that is at least 0.1, 0.2, 0.3, 0.4, 0.5, 0.6, 0.7, 0.8, 0.9, 1.0, 1.1, 1.2, 1.3, 1.4, 1.5, 2, 2.5, 3, 3.5, 4, 5, 6, 7, 8, 9, 10, or more times greater than the hardness of a hardness of solid particulates in the bearing fluid (e.g., mean, average, or maximum hardness of solid particulates). Examples of ceramics that may be used in the cermet of the rotating assembly thrust plate 602 include, but are not limited to, sintered monolithic SiC (silicon carbide), which may be dense or with pores that can be filled with graphite for better tribological properties, or silicon carbide, which may be in the form of reaction bonded silicon carbide. One example of a ceramic includes SiC—SiC (e.g., ceramic matrix composite or CMC), which may include SiC fibers in a matrix of SiC. The CMC may be applied by a chemical vapor infiltration process. The final component of the rotating assembly thrust plate 602 may then be coated with a layer of dense SiC, or any other suitable material, as a protective layer that then becomes the hard bearing surface. Thus, the CMC provides toughness to the monolithic SiC. Other examples of ceramic materials include Si₃N₄ (silicon nitride), Al₂O₃ (alumina), zirconia toughened alumina for improved strength and toughness over pure alumina, or ZrO₂ (zirconia). An example of the cermet includes sintered carbide in a metal binder. Specifically, cemented tungsten carbide may be sintered in a matrix binder that includes a combination of Ni, Cr, and/or Co. Tungsten carbide particles (grains) may be approximately 1 to 5 microns in size. In some cases, sub-micron carbide grains may be used. In addition, the matrix ratio by weight may be between approximately 1% to 25%. The combination of metal binder content and carbide grain size may determine the mechanical strength, fracture toughness, and/or wear resistance of the cermet.

In certain embodiments, various coatings may be applied to low thermal expansion metals to form the rotating assembly thrust plate 602. For example, it is possible to apply hard coatings to metal surfaces with low thermal expansion coefficients, such as certain nickel-iron alloys. One example of such an alloy is INVAR, also known generically as FeNi36 or 64FeNi. The hard coatings may be applied by various thermal spray techniques, such as plasma, high velocity oxygen fuel spraying (HVOF), or high velocity air fuel spraying (HVAF). Examples of coatings that can be applied to metal surfaces with low thermal expansion coefficients include, but are not limited to, tungsten carbide in a metal matrix, which may be CoCr, NiCr, CoCrNi, and so forth, (the matrix ratio may be between approximately 5 to 30 wt %), chrome carbide in a metal matrix (the matrix ratio may be between approximately 5 to 25 wt % and the metal matrix may be NiCr or MCrAlY, where M=metal and can be Ni and/or Co, and so forth), a combination of chrome and tungsten carbides in a metal matrix, or boron carbide (ceramic). Other coating techniques for applying thin hard coatings such as, ZrN (zirconium nitride), AlN (aluminum nitride), ALTN (aluminum titanium nitride), and diamond-like carbon, include physical vapor deposition (PVD) and chemical vapour deposition (CVD) processes on a low thermal expansion coefficient metal substrate. In certain embodiments, boronizing through a thermochemical surface hardening process on a low thermal expansion coefficient metal substrate may be used.

As described in detail below, the rotating assembly thrust plate 602 made from the hard material may be coupled to the impeller 604 using a brazing process. In certain embodiments, a first thermal expansion coefficient of the rotating assembly thrust plate 602 may be selected to be approximately equal to (e.g., within +/−1%, 2%, 3%, 4%, or 5% of) a second thermal expansion coefficient of the impeller 604, thereby reducing or preventing issues associated with the rotating assembly thrust plate 602 and the impeller 604 having different thermal expansion coefficients, such as stress, strain, cracking, and so forth. When cermet is used as the hard material for the rotating assembly thrust plate 602, the ratio of the metal to ceramic (e.g., carbide) may be selected so that the first thermal expansion coefficient of the rotating assembly thrust plate 602 is approximately equal to (e.g., within +/−1%, 2%, 3%, 4%, or 5% of) the second thermal expansion coefficient of the impeller 604. As described in detail above, the stator of the rotating equipment used with the embodiment of the rotating assembly thrust plate 602 may be fixed and/or may include tilted and/or pivot pads.

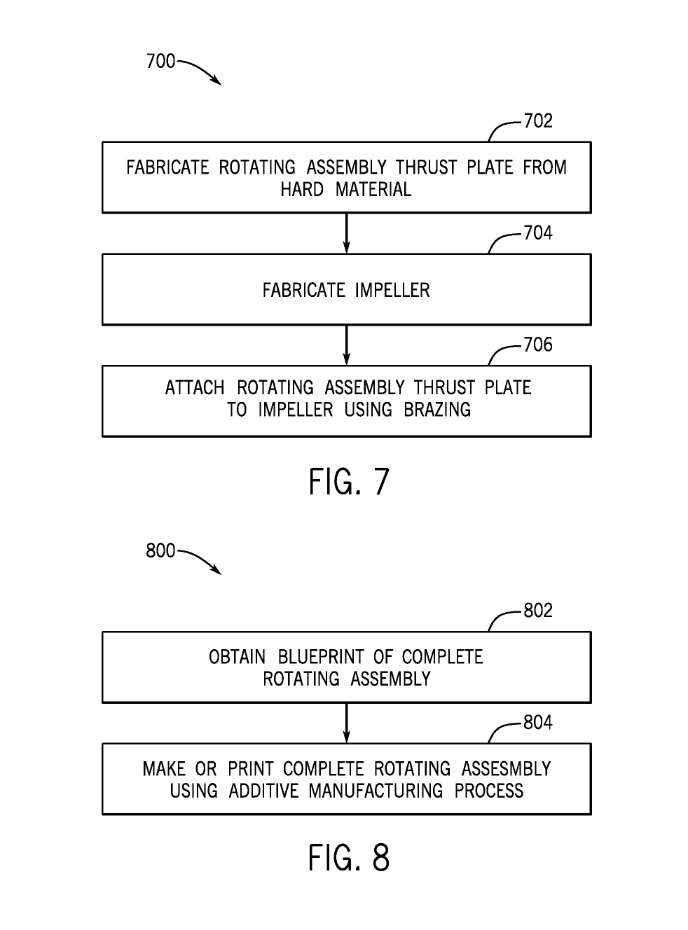

FIG. 7 is a flowchart of a method 700 that may be used to fabricate an embodiment of the rotating assembly thrust plate 602 of FIG. 6 using brazing. Specifically, in a first step 702, the rotating assembly thrust plate 602 may be fabricated from the hard material, such as the hard materials described in detail above. Thus, the rotating assembly thrust plate 602 includes one component made from the hard material. In a second step 704, the impeller 604 or other component of the rotating machinery may be fabricated. In a third step 706, the rotating assembly thrust plate 602 may be coupled or attached to the impeller 604 using brazing. Specifically, brazing is a metal-joining process whereby a filler metal is heated above melting point and distributed between two or more close-fitting parts by capillary action. Thus, after the filler metal is heated above its melting point, the filler metal may be distributed between the rotating assembly thrust plate 602 and the impeller 604, thereby joining the rotating assembly thrust plate 602 to the impeller 604. By using brazing in the disclosed embodiments, the disadvantages of prior methods may be avoided. Specifically, the distortion and high internal stresses associated with mechanical retention methods, such as bolting and adhesives, may be avoided by using brazing. In addition, the degradation associated with use of adhesives in certain operating environments may be avoided by using brazing. In other embodiments, other techniques, such as, but not limited to, soldering, welding, and so forth, may be used to attach the rotating assembly thrust plate 602 to the impeller 604.

FIG. 8 is a flowchart of a method 800 that may be used to fabricate an embodiment of the rotating assembly thrust plate 602 of FIG. 6 using an additive manufacturing process. Specifically, in a first step 802, a blueprint of the complete rotating assembly 600 (e.g., the rotating assembly thrust plate 602 and the impeller 604) may be obtained. In a second step 804, the complete rotating assembly 600 may be made or printed using an additive manufacturing process using the blueprint (e.g., a 3D computer-aided design (CAD) and/or computer-aided manufacturing (CAM) model). An additive manufacturing process (e.g., a 3D printing process) is a process of making a three-dimensional solid object of a particular shape from a digital model (e.g., the blueprint). In the additive manufacturing process, successive layers of material are laid down in different shapes until the solid object is completed. Examples of the additive manufacturing process used to produce the embodiment of the rotating assembly 600 of FIG. 6 include, but are not limited to, granular materials binding, selective laser melting (SLM), direct metal laser sintering (DMLS), selective laser sintering (SLS), selective heat sintering (SHS), electron beam melting (EBM), electron beam freeform fabrication (EBF), extrusion deposition, fused deposition modeling (FDM), photopolymerization, stereolithography (SLA), laminated object manufacturing (LOM), plaster-based 3D printing (PP), digital light processing (DLP), and so forth. By using additive manufacturing processes in the disclosed embodiments, the disadvantages of prior methods may be avoided. Specifically, the distortion and high internal stresses associated with mechanical retention methods, such as bolting and adhesives, may be avoided by using additive manufacturing processes. In addition, the degradation associated with use of adhesives in certain operating environments may be avoided by using additive manufacturing processes.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A method for manufacturing a rotating assembly, comprising:
providing an impeller comprising a shaft and at least one blade;
providing a thrust plate configured to contact a bearing fluid; and
brazing the thrust plate to the impeller.

2. The method of claim 1, wherein the thrust plate comprises a first material having a first hardness greater than a second hardness of solid particulates in the bearing fluid.

3. The method of claim 2, wherein the first material comprises a cemented carbide.

4. The method of claim 2, wherein the first material comprises a ceramic.

5. The method of claim 2, wherein providing the thrust plate comprises fabricating the thrust plate using the first material and coating the first material with a second material.

6. The method of claim 5, wherein coating the first material comprises boronizing the first material.

7. The method of claim 5, wherein coating the first material comprises applying the second material to the first material using high velocity oxygen fuel spraying or high velocity air fuel spraying.

8. The method of claim 5, wherein coating the first material comprises applying the second material to the first material using chemical vapor deposition or physical vapor deposition.

9. The method of claim 1, wherein the thrust plate comprises a first thermal expansion coefficient and the impeller comprises a second thermal expansion coefficient within plus or minus 5 percent of the first thermal expansion coefficient.

10. A method for manufacturing a rotating assembly, comprising:
providing a blueprint of the rotating assembly, wherein the rotating assembly comprises an impeller and a thrust pad, and wherein the impeller comprises a shaft and at least one blade; and
fabricating at least a portion of the rotating assembly using an additive manufacturing process based on the blueprint.

11. The method of claim 10, wherein the additive manufacturing process comprises granular materials binding, selective laser melting, direct metal laser sintering, or selective laser sintering.

12. The method of claim 10, wherein the thrust pad is configured to contact a bearing fluid, and wherein the thrust pad comprises a material having a first hardness greater than a second hardness of a solid particulate in the bearing fluid.

13. The method of claim 10, wherein fabricating at least a portion of the rotating assembly comprises fabricating at least a portion of the rotating assembly using a cemented carbide or a ceramic.

14. The method of claim 10, comprising applying a coating to the thrust pad of the rotating assembly after at least a portion of the rotating assembly is fabricated.

15. A system, comprising:
a rotating assembly, comprising:
an impeller comprising a shaft and at least one blade; and
a thrust plate coupled to the impeller and configured to contact a bearing fluid, wherein the thrust plate comprises a first material comprising a first hardness greater than a second hardness of a solid particulate in the bearing fluid.

16. The system of claim 15, comprising a pump having the rotating assembly.

17. The system of claim 15, comprising a turbine having the rotating assembly.

18. The system of claim 15, wherein a first thermal expansion coefficient of the thrust plate is within plus or minus 5 percent of a second thermal expansion coefficient of the impeller.

19. The system of claim 15, wherein the thrust plate comprises a cemented carbide or a ceramic.

20. The system of claim 15, wherein the thrust plate is substantially perpendicular to a rotational axis of the impeller.
